(19) United States
(12) Patent Application Publication
(10) Pub. No.: US 2025/0356874 A1
(43) Pub. Date: Nov. 20, 2025

(54) ARTIFICIAL INTELLIGENCE DEVICE AND OPERATING METHOD THEREOF

(71) Applicants: LG ELECTRONICS INC., Seoul (KR); Korea Advanced Institute of Science and Technology, Daejeon (KR)

(72) Inventors: Jewoo RYU, Seoul (KR); Yunhee KU, Seoul (KR); Heepyung KIM, Daejeon (KR); Yong JEONG, Daejeon (KR); Uichin LEE, Daejeon (KR)

(73) Assignees: LG ELECTRONICS INC., Seoul (KR); Korea Advanced Institute of Science and Technology, Daejeon (KR)

(21) Appl. No.: 19/004,079

(22) Filed: Dec. 27, 2024

(30) Foreign Application Priority Data
May 17, 2024 (WO) PCT/KR2024/006733

(51) Int. Cl. G10L 25/63; G06F 3/01

(52) U.S. Cl. CPC G10L 25/63; G06F 3/015; G06F 2203/011

(57) ABSTRACT

According to an embodiment of the present disclosure, an artificial intelligence device may comprise a sensor configured to collect biometric data of a user, log data of the user, and voice data corresponding to a voice uttered by the user and a processor configured to calculate a plurality of probabilities corresponding to each of a plurality of emotional states based on the voice data, obtain a weight for one or more emotional states based on the biometric data and the log data, and determine a final emotional state by reflecting the obtained weight on the plurality of emotional states.

### CROSS-REFERENCE TO RELATED APPLICATION

Pursuant to 35 U.S.C. § 119 (a), this application claims the benefit of earlier filing date and right of priority to International Application No. PCT/KR2024/006733, filed on May 17, 2024, the contents of which are all incorporated by reference herein in its entirety.

### BACKGROUND OF THE INVENTION

### 1. Field of the Invention

The present invention relates to an artificial intelligence device, and more specifically, to an artificial intelligence device capable of measuring a user's emotional state.

### 2. Discussion of the Related Art

Emotion analysis technology using voice signal has continued to develop steadily in recent years.

In particular, emotion analysis technology using voice signal is a technology that analyzes the user's emotional state through deep learning and machine learning.

These developments are evolving voice emotion analysis technology to a more accurate and reliable level, increasing its potential for use in application field such as voice-based service and personal assistant.

However, the conventional emotion analysis technology based on voice signal has the problem of not ensuring accuracy in analyzing the user's emotional state.

### SUMMARY OF THE INVENTION

The purpose of the present disclosure may be to accurately analyze the user's emotional state using the user's voice, biometric data, and life log data.

The purpose of the present disclosure may be to accurately obtain the user's emotional state by weighting the emotional state based on the user's voice.

According to an embodiment of the present disclosure, an artificial intelligence device may comprise a sensor configured to collect biometric data of a user, log data of the user, and voice data corresponding to a voice uttered by the user and a processor configured to calculate a plurality of probabilities corresponding to each of a plurality of emotional states based on the voice data, obtain a weight for one or more emotional states based on the biometric data and the log data, and determine a final emotional state by reflecting the obtained weight on the plurality of emotional states.

According to an embodiment of the present disclosure, an operating method of an artificial intelligence device may comprise collecting biometric data of a user, log data of the user, and voice data corresponding to a voice uttered by the user, calculating a plurality of probabilities corresponding to each of a plurality of emotional states based on the voice data, obtaining a weight for one or more emotional states based on the biometric data and the log data, and determining a final emotional state by reflecting the obtained weight on the plurality of emotional states.

According to an embodiment of the present disclosure, classification accuracy of emotional state can be improved by applying physical fitness status based on heart rate and heart rate variability and context data based on the user's life log to a voice-based classification model.

According to an embodiment of the present disclosure, the performance of emotion classification can be improved by adding context recognition-based weighting to the existing voice recognition-based emotional state classification.

### BRIEF DESCRIPTION OF THE DRAWINGS

FIG. 1 is a block diagram for illustrating elements of an artificial intelligence device according to an embodiment of the present disclosure.

FIG. 2 is a diagram for illustrating the configuration of an artificial intelligence server according to an embodiment of the present disclosure.

FIG. 3 is a diagram for illustrating the configuration of an artificial intelligence system according to an embodiment of the present disclosure.

FIG. 4 is a flowchart illustrating a method of operating an artificial intelligence system according to an embodiment of the present disclosure.

FIG. 5 is a flowchart illustrating a process of determining a user's emotional state through a voice-based emotion classification model according to an embodiment of the present disclosure.

FIG. 6 is a flowchart illustrating a method of calculating weight according to the first embodiment of the present disclosure.

FIG. 7 is a diagram showing emotional states according to an embodiment of the present disclosure.

FIG. 8 is a diagram illustrating an example of deriving a final emotional state according to a weight assigned according to the first embodiment of the present disclosure.

FIG. 9 is a flowchart illustrating a method of calculating weight according to a second embodiment of the present disclosure.

FIG. 10 is a diagram illustrating an example of deriving a final emotional state according to a weight assigned according to a second embodiment of the present disclosure.

FIG. 11A is a diagram illustrating the accuracy of emotional state classified based on only voice signal according to the prior art, and FIG. 11B is a diagram illustrating the accuracy of emotional state classified based on voice data, log data, and biometric data according to an embodiment of the present disclosure.

FIG. 12 is a diagram illustrating the configuration of an artificial intelligence device according to an embodiment of the present disclosure.

### DETAILED DESCRIPTION OF THE PREFERRED EMBODIMENTS

Artificial intelligence refers to the field of researching artificial intelligence or methodology to create it, and machine learning refers to the field of defining various problems dealt with in the field of artificial intelligence and researching methodology to solve them.

Machine learning is also defined as an algorithm that improves the performance of a task through consistent experience.

Artificial Neural Network (ANN) is a model used in machine learning and it can refer to an overall model with problem-solving capability that is composed of artificial neurons (nodes) that form a network through the combination of synapses.

Artificial neural network can be defined by connection patterns between neurons in different layers, a learning process that updates model parameter, and an activation function that generates output value.

An artificial neural network may include an input layer, an output layer, and optionally one or more hidden layers. Each layer may include one or more neurons, and the artificial neural network may include synapse connecting neurons. In an artificial neural network, each neuron may output the activation function value for the input signals, weight, and bias input through the synapse.

Model parameter refer to parameters determined through learning and includes the weight of synaptic connection and the bias of neuron. Hyperparameter refer to a parameter that must be set before learning in a machine learning algorithm and includes learning rate, number of repetition, mini-batch size, initialization function, etc.

The purpose of artificial neural network learning may be seen as determining model parameter that minimize the loss function. The loss function may be used as an indicator to determine optimal model parameter in the learning process of an artificial neural network.

Machine learning may be classified into supervised learning, unsupervised learning, and reinforcement learning depending on the learning method.

Supervised learning may refer to a method of training an artificial neural network with a label for the learning data given and a label is the correct answer (or result value) that the artificial neural network must infer when learning data is input to the artificial neural network.

Unsupervised learning may refer to a method of training an artificial neural network in a state where no label for training data is given.

Reinforcement learning may refer to a learning method in which an agent defined within an environment learns to select an action or action sequence that maximize the cumulative reward in each state.

Among artificial neural networks, machine learning implemented with a deep neural network (DNN) that includes multiple hidden layers is also called deep learning, and deep learning is a part of machine learning.

Hereinafter, machine learning is used to include deep learning.

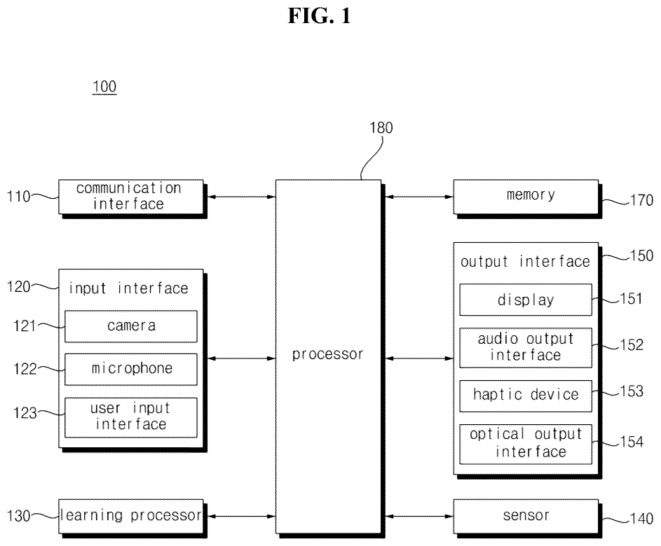

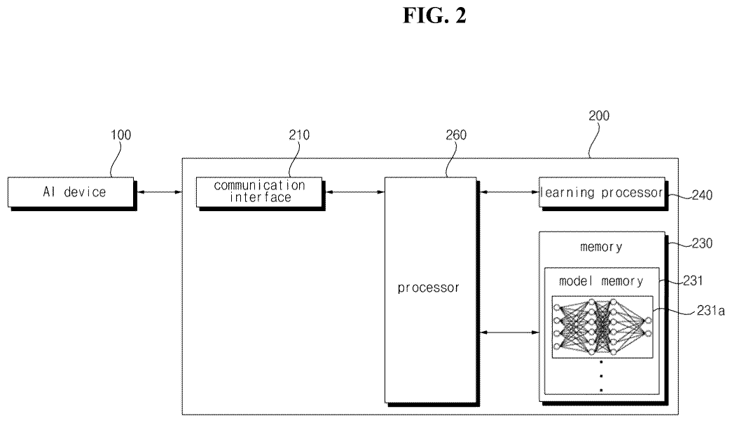

FIG. 1 is a block diagram for illustrating elements of an artificial intelligence device according to an embodiment of the present disclosure.

The artificial intelligence device 100 may be implemented to a fixed or movable device such as a TV, a projector, a mobile phone, a smartphone, a desktop computer, a laptop, a digital broadcasting terminal, a PDA (personal digital assistant), a PMP (portable multimedia player), a navigation, a tablet PC, a wearable device, a set-top box (STB), a DMB receiver, radio, washing machine, refrigerator, a digital signage, robot, vehicle, etc.

Referring to FIG. 1, the artificial intelligence device 100 may include a communication interface 110, an input interface 120, a learning processor 130, a sensor 140, an output interface 150, a memory 170, and a processor 180.

The communication interface 110 may transmit and receive data with an external device such as other an artificial intelligence device or an AI server 200 using wired or wireless communication technology. For example, the communication interface 110 may transmit and receive sensor information, user input, learning model, and control signal with the external device.

Communication technology used by the communication interface 110 includes Global System for Mobile communication (GSM), Code Division Multi Access (CDMA), Long Term Evolution (LTE), 5G, Wireless LAN (WLAN), and Wireless-Fidelity (Wi-Fi), Bluetooth, RFID (Radio Frequency Identification), Infrared Data Association (IrDA), ZigBee, NFC (Near Field Communication), etc.

The input interface 120 may acquire various types of data.

The input interface 120 may include a camera 121 for capturing images, a microphone 122 for receiving audio signal, and a user input interface 123 for receiving information from a user.

The camera 121 or the microphone 122 is treated as a sensor, and the signal obtained from the camera 121 or the microphone 122 may be called sensing data or sensor information.

The input interface 120 may obtain training data for model learning and input data to be used when obtaining an output using the learning model. The input interface 120 may acquire unprocessed input data, and in this case, the processor 180 or the learning processor 130 may extract an input feature by preprocessing the input data.

The camera 121 processes image frame such as a still image or a moving image obtained by an image sensor in video call mode or shooting mode. Processed image frame may be displayed on display 151 or stored in memory 170.

The microphone 122 processes external audio signal into electrical voice data. The processed audio data may be utilized in various ways according to the function (or application being executed) being performed by the artificial intelligence device 100. Meanwhile, various noise removal algorithms may be applied to the microphone 122 to remove noise generated in the process of receiving an external audio signal.

The user input interface 123 is for receiving information from the user. When information is input through the user input interface 123, the processor 180 may control the operation of the artificial intelligence device 100 to correspond to the input information.

The user input interface 123 is a mechanical input mean (or a mechanical key, for example, a button, a dome switch, a jog wheel, or a jog switch located on the front/rear or side of the artificial intelligence device 100, etc.) and a touch input means.

As an example, the touch input means consists of a virtual key, a soft key, or a visual key displayed on the touch screen through software processing, or a touch key placed in a part other than the touch screen.

The learning processor 130 may train a model composed of an artificial neural network using training data. The learned artificial neural network may be referred to as a learning model. A learning model may be used to infer a result value for new input data other than learning data, and the inferred value may be used as the basis for a decision to perform an operation.

The learning processor 130 may perform AI processing together with the learning processor 240 of the AI server 200.

The learning processor 130 may include memory integrated or implemented in artificial intelligence device 100. The learning processor 130 may be implemented using the memory 170, an external memory directly coupled to the artificial intelligence device 100, or a memory maintained in an external device.

The sensor 140 may use various sensors to obtain at least one of internal information of the artificial intelligence device 100, information about the surrounding environment of the artificial intelligence device 100, and user information.

The sensor 140 is one or more of a proximity sensor, an illumination sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar sensor, and a radar sensor. may include.

The output interface 150 may generate output related to a vision, a hearing, or a tactile sensation.

The output interface 150 may include a display 151 that outputs an image, an audio output interface 152 that outputs audio, a haptic device 153 that outputs tactile information, and an optical output interface 154 that outputs a light.

The display 151 displays (outputs) information processed by the artificial intelligence device 100. For example, the display 151 may display execution screen information of an application running on the artificial intelligence device 100, or user interface (UI) and graphic user interface (GUI) information according to the execution screen information.

The display 151 may be implemented as a touch screen by forming a mutual layer structure or being integrated with the touch sensor. The touch screen may function as a user input interface 123 that provides an input interface between the artificial intelligence device 100 and the user, and may simultaneously provide an output interface between the artificial intelligence device 100 and the user.

The audio output interface 152 may output audio data received from the communication interface 110 or stored in the memory 170 in call signal reception, a call mode or a recording mode, a voice recognition mode, a broadcast reception mode, etc.

The audio output interface 152 may include at least one of a receiver, a speaker, and a buzzer.

The haptic device 153 generates various tactile effects that the user can feel. A representative example of a tactile effect generated by the haptic device 153 may be a vibration.

The light output interface 154 uses light from the light source of the artificial intelligence device 100 to output a signal to notify that an event has occurred. Examples of events that occur in the artificial intelligence device 100 may include receiving a message, receiving a call signal, a missed call, an alarm, a schedule notification, receiving an email, receiving information through an application, etc.

The memory 170 may store data supporting various functions of the artificial intelligence device 100. For example, the memory 170 may store input data obtained from the input interface 120, learning data, a learning model, a learning history, etc.

The processor 180 may determine at least one executable operation of the artificial intelligence device 100 based on information determined or generated using a data analysis algorithm or a machine learning algorithm.

The processor 180 may control the elements of the artificial intelligence device 100 to perform the determined operation.

To this end, the processor 180 may request, retrieve, receive, or utilize data from the learning processor 130 or the memory 170, and may control elements of the artificial intelligence device 100 to perform an operation that is predicted or an operation that is determined to be desirable among the at least one executable operation.

If a linkage with an external device is necessary to perform a determined operation, the processor 180 may generate a control signal to control the external device and transmit the generated control signal to the external device.

The processor 180 may obtain intent information for user input and determine the user's request based on the obtained intent information.

The processor 180 may obtain intent information corresponding to a user input using at least one of a STT (Speech To Text) engine for converting voice input into a character string or a Natural Language Processing (NLP) engine for acquiring intent information of natural language.

At least one of the STT engine and the NLP engine may be composed of at least a portion of an artificial neural network learned according to a machine learning algorithm. And, at least one of the STT engine or the NLP engine may be learned by the learning processor 130, learned by the learning processor 240 of the AI server 200, or learned by distributed processing thereof.

The processor 180 may collect history information including the user's feedback on the operation of the artificial intelligence device 100 to store it in the memory 170 or the learning processor 130 or transmit it to external device such as the AI server 200, etc. The collected historical information may be used to update the learning model.

The processor 180 may control at least some of the elements of the artificial intelligence device 100 to run an application program stored in the memory 170.

The processor 180 may operate two or more of the elements included in the artificial intelligence device 100 in combination with each other in order to run the application program.

FIG. 2 is a diagram for illustrating the configuration of an artificial intelligence server according to an embodiment of the present disclosure.

Referring to FIG. 2, the AI server 200 may refer to a device that trains an artificial neural network using a machine learning algorithm or uses a learned artificial neural network.

The AI server 200 may be composed of a plurality of servers to perform distributed processing, and may be defined as a 5G network. The AI server 200 may be included as a part of the artificial intelligence device 100 and may perform at least part of the AI processing.

The AI server 200 may include a communication interface 210, a memory 230, a learning processor 240, and a processor 260.

The communication interface 210 may transmit and receive data with an external device such as the artificial intelligence device 100.

Memory 230 may include a model memory 231. The model memory 231 may store a model (or artificial neural network, 231a) that is being trained or has been learned through the learning processor 240.

The learning processor 240 may train the artificial neural network 231a using training data. The learning model may be used while mounted on the AI server 200 of the artificial neural network, or may be mounted and used on an external device such as the artificial intelligence device 100.

Learning models may be implemented in a hardware, a software, or a combination of hardware and software. When part or all of the learning model is implemented as software, one or more instructions constituting the learning model may be stored in the memory 230.

The processor 260 may infer a result value for new input data using a learning model and generate a response or control command based on the inferred result value.

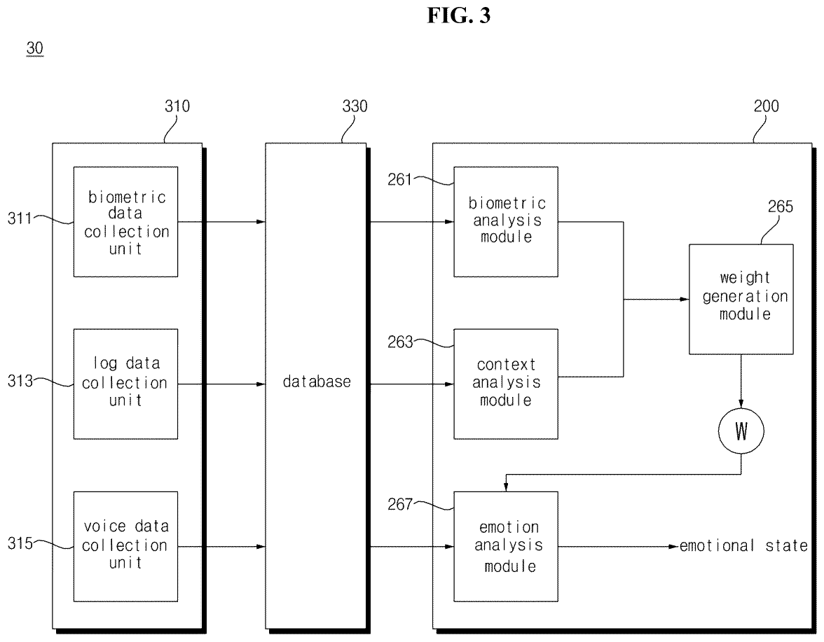

FIG. 3 is a diagram for illustrating the configuration of an artificial intelligence system according to an embodiment of the present disclosure.

Referring to FIG. 3, the artificial intelligence system 30 according to an embodiment of the present disclosure may include a data collection unit 310, a database 330, and an artificial intelligence server 200.

The data collection unit 310 may include a biometric data collection unit 311 that collects the user's biometric data, a log data collection unit 313 that collects the user's log data, and a voice data collection unit 315 that collects the user's voice data.

The biometric data collection unit 311 may collect the user's biometric data. The biometric data collection unit 311 may collect the user's biometric data through the user's wearable device or an IoT device installed in the user's home.

The biometric data collection unit 311 may include one or more of wearable devices or IoT devices installed in the user's home.

The log data collection unit 313 may collect user log data. Log data may be data related to a user activity. The log data collection unit 313 may collect log data through one or more of the user's smartphone or home appliance.

The log data collection unit 313 may include one or more of the user's smartphone or home appliance.

The voice data collection unit 315 may collect voice data corresponding to the voice uttered by the user. The voice data collection unit 315 may collect voice data through a smart speaker or a device equipped with a microphone.

The voice data collection unit 315 may include one or more of a smart speaker or a microphone.

The database 330 may store data collected from each of the biometric data collection unit 311, the log data collection unit 313, and the voice data collection unit 315. The database 330 may be the memory 230 of the AI server 200 of FIG. 2.

The artificial intelligence server 200 may include a biometric analysis module 261, a context analysis module 263, a weight generation module 265, and an emotion analysis module 267.

The biometric analysis module 261, the context analysis module 263, the weight generation module 265, and the emotion analysis module 267 may be included in the processor 260 of FIG. 2.

The biometric analysis module 261 may determine whether the user's heart rate change rate is outside a certain rate based on the biometric data. The biometric analysis module 261 may count the number of times the user's heart rate change rate deviates by a certain rate.

The context analysis module 263 may detect user activity based on log data.

The weight generation module 265 may obtain a weight for the emotional state based on biometric data and log data.

The weight generation module 265 may calculate a weight to be assigned to one or more emotional states when the user's activity is not detected and the number of times the heart rate change rate is more than a certain rate is more than a threshold number.

The weight generation module 265 may obtain the HRV arousal score and the Baevsky stress index when the user's activity is not detected and the heart rate change rate is above a certain rate.

The weight generation module 265 may calculate a weight for each of the plurality of emotional states based on the obtained HRV arousal score and Baevsky stress index.

The emotion analysis module 267 may obtain a voice-based emotional state based on voice data stored in the database 330.

The emotion analysis module 267 may obtain the user's emotional state from voice data using an artificial neural network-based emotion classification model. The emotion analysis module 267 may output the largest value among the probability values of each of the plurality of emotional states obtained through the emotion classification model as the emotional state.

The emotion analysis module 267 may output a final emotional state by assigning a weight to one or more probability values of each of the plurality of emotional states obtained through the emotion classification model.

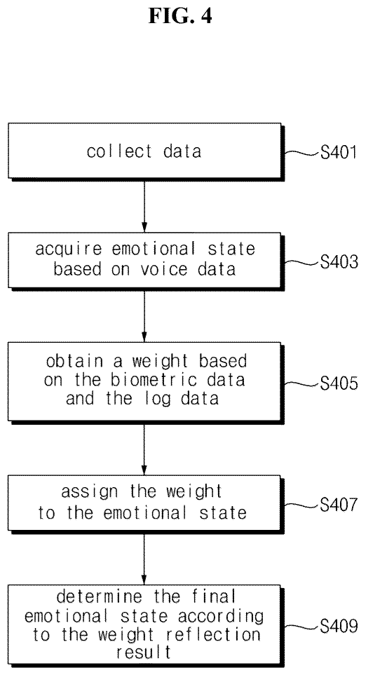

FIG. 4 is a flowchart illustrating a method of operating an artificial intelligence system according to an embodiment of the present disclosure.

Hereinafter, the operating method of the artificial intelligence system will be described with reference to the configuration of the artificial intelligence system 30 in FIG. 3.

The data collection unit 310 of the artificial intelligence system 30 may collect data (S401).

The data collection unit 310 may collect biometric data, log data, and voice data.

Biometric data may include one or more of the user's heart rate and heart rate variability (HRV).

Log data may be data related to user activity. Log data may include one or more of the user's number of steps, GPS data indicating the user's location, environmental data (temperature, humidity) of the space where the user is located, or usage data of a home appliance.

The usage data of the home appliance may be data indicating whether the home appliance is in use. The usage data of the home appliance may include one or more of the time when the operation of the home appliance was turned on and when it was stopped. For example, when the opening and closing of the refrigerator door is detected, the processor 260 may determine that the user's activity has been detected.

Voice data may be data representing a voice uttered by a user.

The AI server 200 of the artificial intelligence system 30 may acquire a voice-based emotional state based on voice data included in the data (S403).

The processor 260 of the AI server 200 may obtain the user's emotional state from voice data using an artificial neural network-based emotion classification model.

The emotion classification model may be stored in the model memory 231 of the AI server 200. The emotion classification model is a model learned through machine learning and may be learned through a supervised learning algorithm such as Support Vector Machine.

An emotion classification model may be a model that classifies an emotional state based on voice features extracted from voice data.

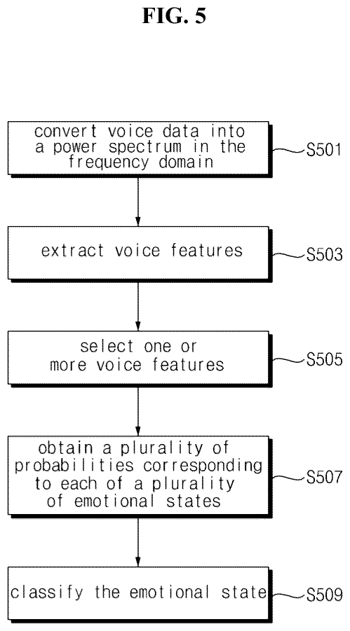

FIG. 5 is a flowchart illustrating a process of determining a user's emotional state through a voice-based emotion classification model according to an embodiment of the present disclosure.

Referring to FIG. 5, the processor 260 of the AI server 200 may convert voice data (or voice signal) into a power spectrum in the frequency domain (S501).

The processor 260 may convert voice data into a power spectrum using Fourier transform. A power spectrum is a graph showing the power of a voice signal according to frequency.

The processor 260 of the AI server 200 may extract voice features of voice data from the power spectrum (S503).

The processor 260 may extract voice features from the power spectrum using a MFCC (Mel-Frequency Cepstral Coefficient) technique. The Voice feature may represent a feature vector.

The MFCC technique may be a technique that converts the power spectrum to Mel scale, converts the Mel scale conversion result to log scale, and extracts voice features through cepstral analysis of the log scale conversion result.

The processor 260 of the AI server 200 may select one or more voice features from the extracted voice features (S505).

The processor 260 may select one or more voice features from the voice features through either correlation analysis or variance analysis.

Correlation analysis may be a method of analyzing the correlation between voice features and removing features with low correlation.

Variance analysis may be a method of calculating the variance of each voice feature and removing features with small variance.

The processor 260 of the AI server 200 may input one or more feature vectors corresponding to one or more voice features selected into the emotion classification model and obtain a plurality of probabilities corresponding to each of a plurality of emotional states (S507).

The plurality of emotional states may include a happy state, a surprised state, a fear state, a sad state, a disgust state, an angry state, and a neutral state. In the embodiment of the present disclosure, seven emotional states are explained as examples, but this is only an example.

The emotion classification model may output a probability of being classified into each of a plurality of emotional states from one or more feature vectors corresponding to one or more selected voice features.

The processor 260 of the AI server 200 may classify the emotional state corresponding to the highest probability among the plurality of probabilities as the user's emotional state (S509).

Again, FIG. 4 will be described.

The AI server 200 of the artificial intelligence system 30 may obtain a weight based on the biometric data and the log data (S405) and assign the weight to the emotional state (S407).

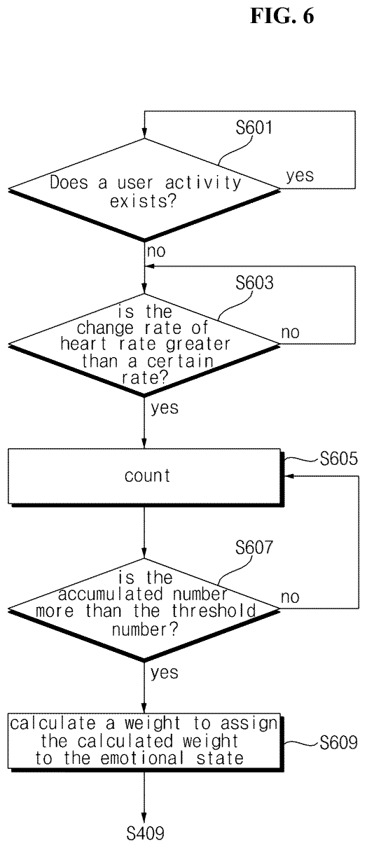

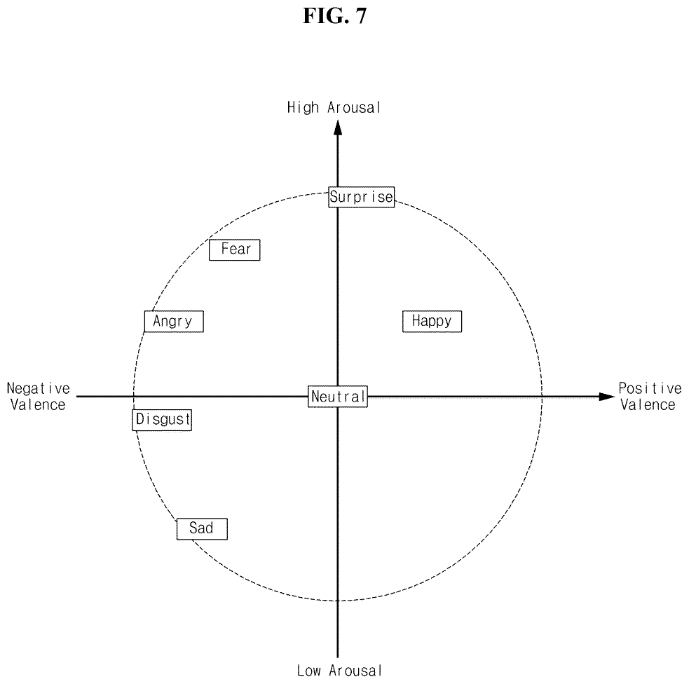

This will be explained with reference to FIG. 6.

FIG. 6 is a flowchart illustrating a method of calculating weights according to the first embodiment of the present disclosure.

Referring to FIG. 6, the processor 260 of the AI server 200 may determine whether a user activity exists based on log data (S601).

In one embodiment, the processor 260 may determine that there is user activity if the user's steps are detected based on acceleration data, and may determine that there is no user activity if the user's steps are not detected.

In another embodiment, the processor 260 may determine that there is the user activity if the user's location movement is detected based on the user's GPS data, and if the user's location movement is not detected, the processor 260 may determine that there is no the user's activity.

In another embodiment, the processor 260 may determine that there is user activity when the home appliance operates based on usage data of the home appliance, and determine that here is no user activity when the home appliance does not operate.

The processor 260 may determine whether the user activity exists based on log data acquired over a certain period of time.

If it is determined that there is no user activity, the processor 260 of the AI server 200 may determine whether the change rate of heart rate included in the biometric data is greater than a certain rate (S603).

The certain rate may be either +10% or −10%, but this is only an example.

The processor 260 may determine whether the change rate of heart rate has changed by a certain rate or more during a unit time.

When it is determined that the heart rate change rate has changed by the certain rate or more, the processor 260 of the AI server 200 may count the number of times the heart rate change rate is more than a certain rate (S605).

The processor 260 may count the number of times the heart rate change rate is greater than the certain rate when the user's activity is not detected.

If the accumulated number according to the count is more than the threshold number (S607), the processor 260 of the AI server 200 may calculate a weight to be reflected in the emotional state to assign the calculated weight to the emotional state (S609).

If the user's activity is not detected and the accumulated number is more than a threshold, the processor 260 may calculate a weight to be assigned to one or more emotional states. Here, the weight may be a fixed value or a value that may vary depending on the change rate of heart rate.

For example, if the user's activity is not detected and the cumulative number of heart rate changes increased by a certain rate is more than a threshold number, the processor 260 assign a weight having a certain value to each of the surprised state, fear state, angry state, and happy state.

Here, the constant value may be 0.02, but it is only an example.

As another example, the processor 260 may assign a weight having a certain value to each of the disgusting state and the sad state when the user's activity is not detected and the cumulative number that the change rate of the heart rate decreases by a certain rate is more than a threshold number.

As another example, if the user's activity is not detected and the cumulative number that the heart rate exceed a certain rate is more than a threshold number, the processor 260 may calculate a weight of the emotional state based on one or more of the change rate or the threshold number.

For example, if the user's activity is not detected and the cumulative number that the heart rate changes by 10% is more than or equal to the threshold number, the processor 260 may obtain a weight of 0.02 for the corresponding emotional state. If the cumulative number that the heart rate changes by 20% is more than or equal to the threshold number, the processor 260 may obtain a weight of 0.03 for the corresponding emotional state.

If the user's activity is not detected and the cumulative number that the heart rate changes by a certain rate is 5 or more, the processor 260 may obtain a weight of 0.02 for the corresponding emotional state. The processor 260 may obtain a weight of 0.03 for the corresponding emotional state when the cumulative number that the heart rate changes by the certain rate is 10 or more.

Meanwhile, emotional states may be classified into a total of 7 types.

FIG. 7 is a diagram showing emotional states according to an embodiment of the present disclosure.

FIG. 7 may be a modified model of the Russell model for emotion classification.

The horizontal axis of the modified model may represent the valence or negativity of an emotion.

The vertical axis of the modified model may represent the arousal of emotion.

In the modified model, multiple emotional states may include a happy state, a surprised state, a fear state, a sad state, a disgust state, a angry state, and a neutral state.

If the user's activity is not detected and the number of times that the heart rate increases by a certain rate is more than a threshold number, the processor 260 may assign a weight of 0.02 to each of emotional states (surprised state, fear state, happy state, angry state) on the positive y-axis.

If the user's activity is not detected and the number of times that the change rate of heart rate is more than a certain rate is more than a threshold number, the processor 260 may assign a weight of 0.02 to each of the emotional states (surprised state, fear state, happy state, angry state) on the positive y-axis.

If the user's activity is not detected and the number of times that the change rate of the heart rate is reduced by a certain rated is more than a threshold number, the processor 260 may assign a weight of 0.02 to each of the emotional states (sad state, disgust state) on the negative y-axis.

Again, FIG. 4 will be described.

The AI server 200 of the artificial intelligence system 30 may determine the final emotional state according to the weight reflection result (S409).

The processor 260 of the AI server 200 may reflect weights on the probability values of each of the seven emotional states output by the voice-based emotion classification model. The processor 260 may obtain the emotional state with the highest probability value as the final emotional state according to the weight reflection result.

The processor 260 may transmit the obtained final emotional state to the artificial intelligence device 100.

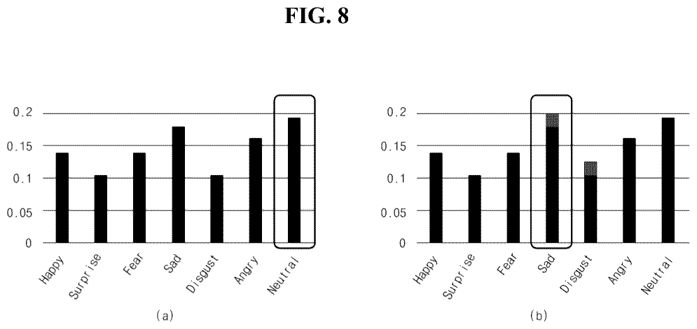

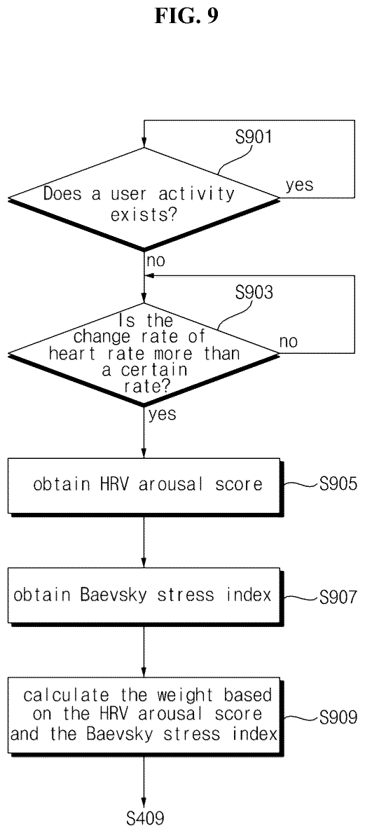

FIG. 8 is a diagram illustrating an example of deriving a final emotional state according to a weight assigned according to the first embodiment of the present disclosure.

(a) of FIG. 8 shows probability values for each of seven emotional states output through a voice-based emotion classification model. In this case, the probability value of the emotional state is the largest in the neutral state.

If the user's activity is not detected and the number of times the change rate of the heart rate is reduced by a certain rate is more than the threshold number, as shown in (b) of FIG. 8, each of the emotional states (sad state, disgusting state) may be assigned to a weight of 0.02. No weight may be assigned to the remaining person's emotional states.

Before weighting, the emotional state with the highest probability value through the voice-based emotion classification model is the neutral state.

However, due to the allocation of weights according to the first embodiment of the present disclosure, the probability value of the sad state became the largest. The processor 260 may determine the sad state as the user's final emotional state.

As such, according to the embodiment of the present disclosure, since emotion classification is performed based on voice signal, user activity, and biometric signal, the accuracy of emotion classification can be greatly improved.

FIG. 9 is a flowchart illustrating a method of calculating weights according to a second embodiment of the present disclosure.

Referring to FIG. 9, the processor 260 of the AI server 200 may determine whether the user activity exists based on log data (S901).

The detailed description of this process will be replaced with the description of step S601 in FIG. 6.

If it is determined that there is no user activity, the processor 260 of the AI server 200 may determine whether the change rate of heart rate included in the biometric data has changed by a certain rate or more (S903).

If the processor 260 of the AI server 200 determines that the change rate of heart rate has changed by a certain rate or more, the processor 260 may obtain an HRV arousal score (S905).

The HRV arousal score may be a score indicating the degree of heart rate variation using the heart rate interval included in biometric data. The HRV arousal score may be used to evaluate the body's stress level or resting state.

HRV Arousal Score may be the result of learning 39 features calculated from IBI (InterBeat Interval) using Random Forest.

HRV Arousal Score is a constant within the range of −1 to 1.

The processor 260 of the AI server 200 may obtain the Baevsky stress index (S907).

The Baevsky stress index may be an indicator that measures stress level based on HRV.

HRV Arousal Score is a constant within the range of −1 to 1.

Baevsky Stress Index may be a unique value calculated from features derived from HRV. Baevsky Stress Index may be calculated by the following [Equation 1].

$$SI = \frac{{AM}_{0} \times 100 \%}{2 {M}_{0} \times {M}_{x} {DM}_{n}} \qquad \{ Equation 1 ]$$

Where Mo is the most frequent heart rate (RR) interval expressed in seconds. The amplitude of AMo was calculated as the number of RR interval of the bin containing Mo using a 50 ms bin width and expressed as a percentage of the total number of intervals measured.

MxDMn is the difference (in seconds) between the longest RR interval value (Mx) and the shortest RR interval value (Mn).

The processor 260 of the AI server 200 may calculate the weight of each emotional state based on the HRV arousal score and the Baevsky stress index (S909), and may reflect the calculated weight to each emotional state.

The processor 260 may calculate the weight using the following [Equation 2].

$$Weight ( w ) = isNotActivation \times ( a \times HRV Arousal score + b \times Baevsky Stress Index ) \qquad [ Equation 2 ]$$

If no activity is detected, isNotActivation may have the value true (=1), and if activity has been detected, isNotActivation may have the value false (=0).

Here, a and b are matrices equal to the number of emotion classifications, and w may be a matrix with a maximum absolute value of 0.2.

a has a matrix value that has a positive correlation with the Angry state, Fear state, and Surprise state, and a negative correlation with the Sad state and Disgust state, and does not reflect weight on the Happy state and Neutral state.

b has a positive correlation with the Angry state, Fear state, Sad state, and Disgust state, a negative correlation with the Happy state, and Surprise state, and has a value of 0 in the Neutral state and does not reflect the weight.

The values of a and b may be eigenvalues calculated by an experiment recruiting 40 people.

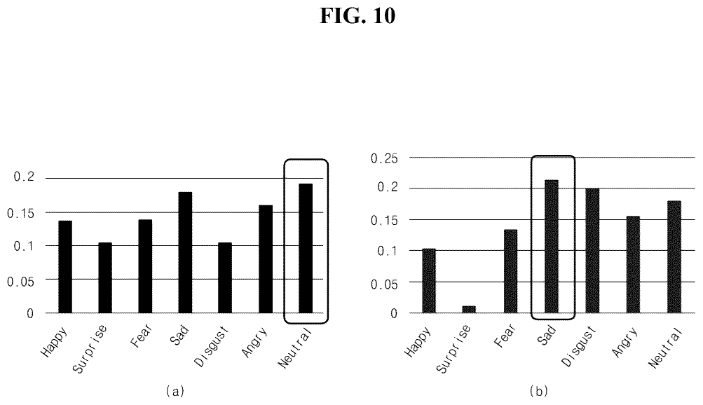

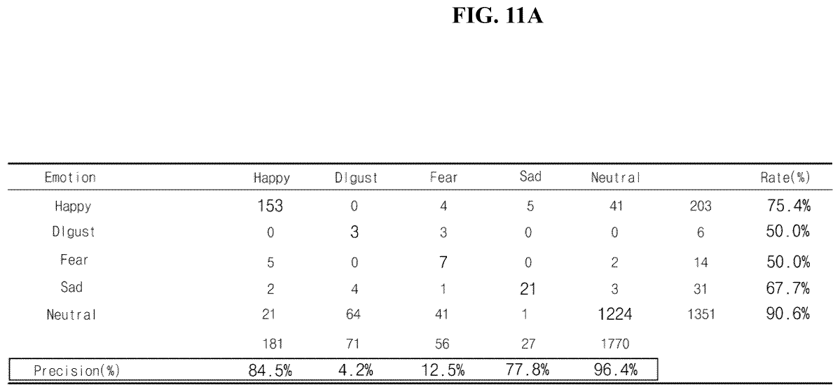

FIG. 10 is a diagram illustrating an example of deriving a final emotional state according to a weight assigned according to a second embodiment of the present disclosure.

(a) of FIG. 10 shows probability values for each of seven emotional states output through a voice-based emotion classification model. In this case, the probability value of the emotional state is the largest for the neutral state.

If the user's activity is not detected and the number of times that the change rate of the heart rate is reduced by a certain rate is more than a threshold number, the processor 260 may calculate a weight to be reflected in each emotional state according to [Equation 2].

The processor 260 may reflect the calculated weights to each emotional state, as shown in (b) of FIG. 10.

Before weighting, the emotional state with the highest probability value through the voice-based emotion classification model is the neutral state.

However, due to the assignment of weights according to the second embodiment of the present disclosure, the probability value of the sad state became the largest. The processor 260 may determine the sad state as the user's final emotional state.

As such, according to the embodiment of the present disclosure, since emotion classification is performed based on voice signal, user activity, and biometric signal, the accuracy of emotion classification can be greatly improved.

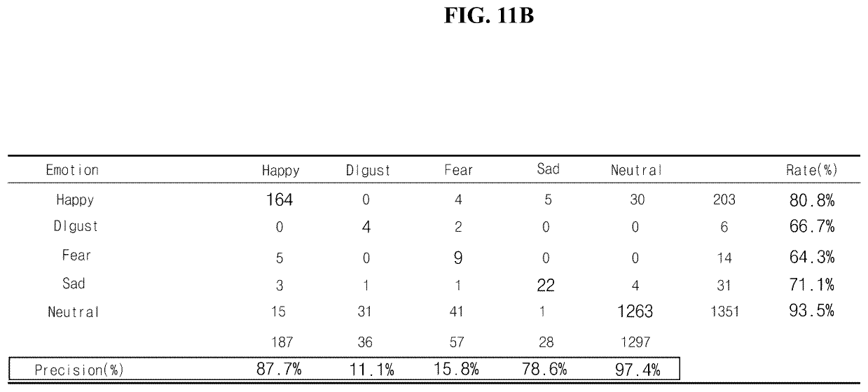

FIG. 11A is a diagram illustrating the accuracy of emotional states classified based on only voice signals according to the prior art, and FIG. 11B is a diagram illustrating the accuracy of emotional state classified based on voice data, log data, and biometric data according to an embodiment of the present disclosure.

In particular, FIG. 11B is a diagram illustrating the accuracy of emotional states classified according to the first embodiment of the present disclosure.

Comparing FIGS. 11A and 11B, the classification accuracy of the happy state increased from 84.5% to 87.7%, the classification accuracy of the disgust state increased from 4.2% to 11.1%, and the classification accuracy of the fear state increased from 12.5% to 15.8%. The classification accuracy of the sad state increased from 77.8% to 78.6%, and the classification accuracy of the neutral state increased from 96.4% to 97.4%.

In this way, according to an embodiment of the present disclosure, the accuracy of emotional states classified based on voice data, log data, and biometric data can be greatly improved compared to the accuracy of emotional states classified based on voice data.

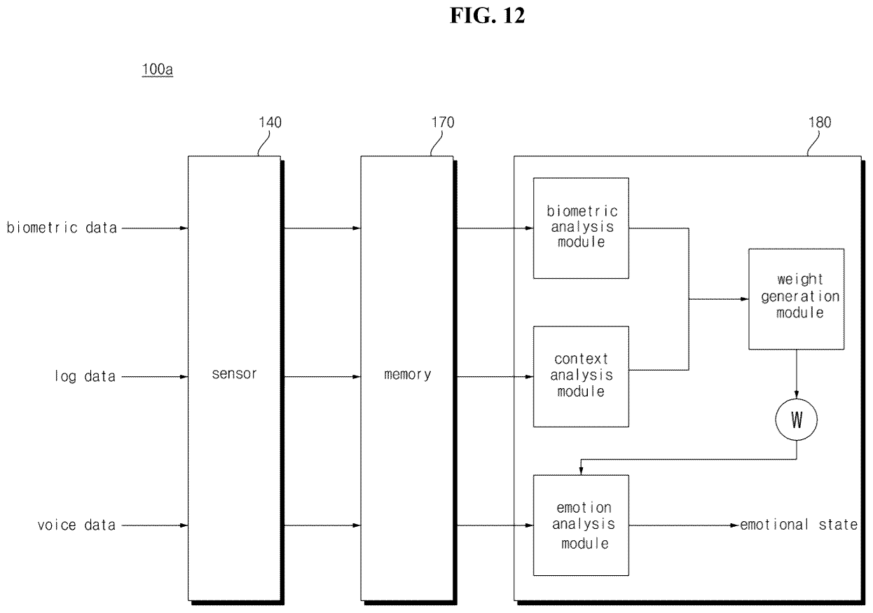

FIG. 12 is a diagram illustrating the configuration of an artificial intelligence device according to an embodiment of the present disclosure.

Embodiments of the present disclosure may be implemented in the artificial intelligence system 30 as shown in FIG. 3, and may also be implemented in the edge device 100a as shown in FIG. 12.

The edge device 100a may include all of the elements shown in FIG. 1. The edge device 100a of FIG. 12 may be an example of the artificial intelligence device 100 of FIG. 1.

In particular, the edge device 100a may include a sensor 140, a memory 170, and a processor 180.

The sensor 140 may collect biometric data, log data, and voice data. The sensor 140 may include a heart rate sensor for collecting biometric data, an acceleration sensor for collecting log data, and a microphone for collecting voice data.

Biometric data may include one or more of the user's heart rate and heart rate variability (HRV).

Log data may be data related to user activity. Log data may include one or more of the user's number of steps, GPS data indicating the user's location, environmental data (temperature, humidity) of the space where the user is located, or usage data of home appliance.

The usage data of the home appliance may be data indicating whether the home appliance is in use. The usage data of the home appliance may include one or more of the time when the operation of the home appliance was turned on and when the operation was stopped. For example, when the opening and closing of the refrigerator door are detected, the processor 180 may determine that the user's activity has been detected.

The edge device 100a may receive usage data of the home appliance from the home appliance through the communication interface 110.

Voice data may be data representing a voice uttered by a user.

The memory 170 may store biometric data, log data, and voice data.

The processor 180 may obtain the user's emotional state from voice data using an artificial neural network-based emotion classification model.

The emotion classification model may be stored in the model memory 170 of the edge device 100a. The emotion classification model is a model learned through machine learning and may be learned through a supervised learning algorithm such as Support Vector Machine.

An emotion classification model may be a model that classifies an emotional state based on voice features extracted from voice data.

The processor 180 may convert voice data (or voice signal) into a power spectrum in the frequency domain.

The processor 180 may convert voice data into a power spectrum using Fourier transform. A power spectrum is a graph showing the power of a voice signal according to frequency.

The processor 180 may extract voice features of voice data from the power spectrum.

The processor 180 may extract voice features from the power spectrum using a MFCC (Mel-Frequency Cepstral Coefficient) technique. Voice features may represent feature vectors.

The MFCC technique may be a technique that converts the power spectrum to Mel scale, converts the Mel scale conversion result to log scale, and extracts voice features through cepstral analysis of the log scale conversion result.

The processor 180 may select one or more voice features from the extracted voice features.

The processor 180 may select one or more voice features from the voice features through either correlation analysis or variance analysis.

Correlation analysis may be a method of analyzing the correlation between voice features and removing features with low correlation.

Variance analysis may be a method of calculating the variance of each voice feature and removing features with small variance.

The processor 180 may obtain a plurality of probabilities corresponding to each of a plurality of emotional states by inputting one or more feature vectors corresponding to one or more voice features selected into the emotion classification model.

The plurality of emotional states may include happy state, surprise state, fear state, sad state, disgust state, angry state, and neutral state. In the embodiment of the present disclosure, seven emotional states are explained as examples, but this is only an example.

The emotion classification model may output a probability of being classified into each of a plurality of emotional states from one or more feature vectors corresponding to one or more selected voice features.

The processor 180 may classify the emotional state corresponding to the highest probability among the plurality of probabilities as the user's emotional state.

The processor 180 may obtain a weight for an emotional state based on biometric data and log data, and assign the obtained weight to the corresponding emotional state.

The processor 180 may calculate a weight to be reflected in the emotional state based on log data and biometric data.

The processor 180 may include a biometric analysis module, a context analysis module, a weight generation module, and an emotion analysis module.

The biometric analysis module may determine whether the user's the change rate of the heart rate is outside a certain rate based on biometric data. The biometric analysis module may count the number of times the user's the change rate of the heart rate deviates by a certain rate.

The context analysis module may detect user activity based on log data.

The weight generation module may obtain a weight for the emotional state based on biometric data and log data.

The weight generation module may calculate a weight to be assigned to one or more emotional states when the user's activity is not detected and the number of times the change rate of the heart rate is more than a certain rate is more than a threshold number.

The weight generation module may obtain the HRV arousal score and Baevsky stress index when the user's activity is not detected and the change rate of the heart rate is above a certain rate.

The weight generation module may calculate a weight for each of a plurality of emotional states based on the obtained HRV arousal score and Baevsky stress index.

The emotion analysis module may obtain a voice-based emotional state based on voice data.

The emotion analysis module may obtain the user's emotional state from voice data using an artificial neural network-based emotion classification model. The emotion analysis module may output the largest value among the probability values of each of the plurality of emotional states obtained through the emotion classification model as the emotional state.

The emotion analysis module may output a final emotional state by assigning a weight to one or more probability values of each of the plurality of emotional states obtained through the emotion classification model.

If the user's activity is not detected based on log data and the change rate of the heart rate deviates by more than a certain rate based on biometric data, the processor 180 may calculate a weight for the emotional state classified based on voice.

The method for calculating and assigning weights may be based on the embodiment of FIG. 6 or FIG. 9. The processor 180 of the edge device 100a may perform all functions performed by the processor 260 of the AI server 200.

The processor 180 may obtain different weight values based on one or more of the degree of heart rate change rate or the size of the threshold number of times.

The processor 180 may determine the final emotional state according to the weight reflection result.

The processor 180 may reflect weights on the probability values of each of the seven emotional states output by the voice-based emotion classification model. The processor 180 may obtain the emotional state with the highest probability value as the final emotional state according to the weight reflection result.

The processor 180 may output the obtained final emotional state through the output interface 150. The processor 180 may display the final emotional state through the display 151 or output it as audio through the audio output interface 152.

The present disclosure described above may be implemented as computer-readable code on a program-recorded medium. Computer-readable media includes all types of recording devices that store data that may be read by a computer system. Examples of computer-readable media include HDD (Hard Disk Drive), SSD (Solid State Disk), SDD (Silicon Disk Drive), ROM, RAM, CD-ROM, magnetic tape, floppy disk, optical data storage device, etc. Additionally, the computer may include a processor 180 of an artificial intelligence device.

What is claimed is:

1. An artificial intelligence device comprising:
a sensor configured to collect biometric data of a user, log data of the user, and voice data corresponding to a voice uttered by the user; and
a processor configured to:
calculate a plurality of probabilities corresponding, respectively, to a plurality of emotional states based on the voice data;
obtain a weight for one or more emotional states of the plurality of emotional states based on the biometric data and the log data; and
determine a final emotional state of the plurality of emotional states reflecting the obtained weight.

2. The artificial intelligence device of claim 1, wherein the processor is further configured to obtain the weight based on activity of the user not being detected based on the log data, and a heart rate included in the biometric data changing by more than a certain rate.

3. The artificial intelligence device of claim 2, wherein the processor is further configured to obtain the weight based on the activity of the user not being detected based on the log data, and a number of times that the heart rate changes by more than the certain rate being more than a threshold number.

4. The artificial intelligence device of claim 3, wherein the plurality of emotional states include a happy state, a surprise state, a fear state, a sad state, a disgust state, an angry state and a neutral state,
wherein the processor is further configured to assign a weight having a certain value to each of the surprise state, the fear state, the angry state, and the happy state based on a cumulative number of times that the heart rate increases by more than the certain rate being more than the threshold number.

5. The artificial intelligence device of claim 4, wherein the processor is further configured to assign a second weight having a certain second value to each of the disgust state and the sad state based on a cumulative number of times that the heart rate decreases by more than the certain rate being more than the threshold number.

6. The artificial intelligence device of claim 3, wherein the processor is further configured to obtain different weight values based on one or more of a degree to which the heart rate changes or the threshold number.

7. The artificial intelligence device of claim 2, wherein the processor is further configured to:
obtain a heart rate variability (HRV) arousal score by learning 39 features calculated from IBI (InterBeat Interval) with Random Forest;
obtain a Baevsky stress index based on [Equation 1],
$$SI = \frac{{AM}_{0} \times 100 \%}{2 {M}_{0} \times {M}_{x} {DM}_{n}} \qquad [ Equation 1 ]$$
wherein Mₒ denotes a most frequent heart rate (RR) interval expressed in seconds, AMₒ denotes an amplitude calculated as a number of RR interval in a bin containing Mₒ using a 50 ms bin width, and MxDMn denotes a difference in seconds between a longest RR interval value (Mₓ) and a shortest RR interval value (Mₙ); and
calculate a weight to be assigned to each of the plurality of emotional states based on [Equation 2],
$$Weight ( w ) = isNotActivation \times ( a \times HRV Arousal score + b \times Baevsky Stress Index ) \qquad [ Equation 2 ]$$
wherein isNotActivation has a value of 0 or 1 depending on whether the activity of the user has been detected,
wherein the plurality of emotional states include a happy state, a surprise state, a fear state, a sad state, a disgust state, an angry state and a neutral state,
wherein a has a matrix value that has a positive correlation with the angry state, the fear state, and the surprise state, has a matrix value that has a negative correlation with the sad state and the disgust state, and does not reflect weight with respect to the Happy state and the Neutral state,
wherein b has a matrix value that has a positive correlation with the angry state, the fear state, the sad state, and the disgust state, has a matrix value that has a negative correlation with the happy state and the surprise state, and has a value of 0 with respect to the neutral state.

8. The artificial intelligence device of claim 1, wherein the biometric data includes one or more of a heart rate of the user or a heart rate variability,
wherein the log data includes one or more of location data of the user or usage data of a home appliance indicating whether the home appliance is used.

9. The artificial intelligence device of claim 1, further comprising a memory configured to store an artificial neural network-based emotion classification model that classifies an emotional state of the user based on the voice data,
wherein the emotion classification model is learned through a supervised learning algorithm comprising a Support Vector Machine.

10. A method of operating an artificial intelligence device, the method comprising:
collecting biometric data of a user, log data of the user, and voice data corresponding to a voice uttered by the user;
calculating a plurality of probabilities corresponding, respectively, to a plurality of emotional states based on the voice data;
obtaining a weight for one or more emotional states of the plurality of emotional states based on the biometric data and the log data; and
determining a final emotional state of the plurality of emotional states reflecting the obtained weight.

11. The method of claim 10, wherein obtaining the weight comprises:
obtaining the weight based on activity of the user not being detected based on the log data, and a heart rate included in the biometric data changing by more than a certain rate.

12. The method of claim 11, wherein obtaining the weight further comprises:
obtaining the weight based on the activity of the user not being detected based on the log data, and a number of times that the heart rate changes by more than the certain rate being more than a threshold number.

13. The method of claim 12, wherein the plurality of emotional states include a happy state, a surprise state, a fear state, a sad state, a disgust state, an angry state and a neutral state,
wherein determining the final emotional state comprises:
assigning a weight having a certain value to each of the surprise state, the fear state, the angry state, and the happy state based on a cumulative number of times that the heart rate increases by more than the certain rate being more than the threshold number.

14. The method of claim 13, wherein determining the final emotional state further comprises:
assigning a second weight having a certain second value to each of the disgust state and the sad state based on a cumulative number of times that the heart rate decreases by more than the certain rate being more than the threshold number.

15. The method of claim 12, wherein obtaining the weight further comprises:
obtaining different weight values based on one or more of a degree to which the heart rate changes or the threshold number.
